(19) United States
(12) Patent Application Publication
(10) Pub. No.: US 2015/0202888 A1
(43) Pub. Date: Jul. 23, 2015

(54) RETAINING JIG, PRINT DEVICE AND PRINT METHOD

(71) Applicant: MIMAKI ENGINEERING CO., LTD., NAGANO (JP)

(72) Inventors: Eiji Miyashita, Nagano (JP); Nobuo Shimizu, Nagano (JP); Takaaki Kanbara, Nagano (JP); Hirofumi Hara, Nagano (JP); Akira Ikeda, Nagano (JP)

(21) Appl. No.: 14/421,150

(22) PCT Filed: Sep. 2, 2013
(86) PCT No.: PCT/JP2013/073582

§ 371 Date: Feb. 12, 2015

(30) Foreign Application Priority Data
Sep. 4, 2012 (JP) 2012-194608
Jan. 18, 2013 (JP) 2013-007909

(51) Int. Cl. B41J 3/407; B41J 29/02

(52) U.S. Cl. CPC B41J 3/407; B41J 29/02

(57) ABSTRACT

A print method for printing efficiently on a plurality of polyhedrons is provided. A retaining jig 10 retains portable terminal casings 20 upon printing print data on print target surfaces configured of a plurality of adjacent surfaces of the portable terminal casings 20 that are polyhedrons. The plurality of portable terminal casings 20 is retained such that one of the print target surfaces of each of the plurality of portable terminal casings 20 is arranged adjacent to each other, boundaries of the adjacent print target surfaces are brought into contact, and the print target surfaces for printing the print data are formed from the surface of the plurality of portable terminal casings 20.

### TECHNICAL FIELD

The present invention relates to a retaining jig that retains a print object, a print device provided with the retaining jig, and a print method using the retaining jig.

### BACKGROUND ART

As a print method for printing on a plurality of surfaces of a print object, a print method described in Patent Document 1 is known. In the print method described in Patent Document 1, a work piece is rotated in a position that faces an ink jet head, and moves a surface of a printing region facing the ink jet head. Due to this, printing on the printing region of the work piece configured of the plurality of surfaces can be performed.

### PRIOR ART DOCUMENT

### Patent Document

Patent Document 1: JP 2011-20112 A (published on Feb. 3, 2011)

### SUMMARY OF THE INVENTION

### Problem to be Solved by the Invention

However, in the print method described in Patent Document 1, since the printing is performed while rotating one work piece set on a rotation unit, the printing must be performed by one surface at a time for the print target surfaces. Accordingly, a long time is required for printing on all of the surfaces, and the printing cannot be performed at a time on the plurality of print objects.

The present invention has been made in view of the above problem, and aims to provide a retaining jig for performing printing efficiently on print target surfaces configured of a plurality of surfaces in a print object, a print device provided with the retaining jig, and a print method using the retaining jig.

### Solutions to the Problem

To solve the above problem, a retaining jig according to the present invention is a retaining jig that retains polyhedrons upon printing print data on print target surfaces formed of a plurality of adjacent surfaces in the polyhedrons, characterized in that the plurality of polyhedrons is retained such that one of the print target surfaces in each of the plurality of the polyhedrons is arranged adjacent to each other, boundaries of the adjacent print target surfaces are brought into contact, and the print target surfaces for printing the print data are formed by the surfaces of the plurality of polyhedrons.

According to the above configuration, the retaining jig retains the polyhedrons upon printing the print data on the print target surfaces configured of the plurality of adjacent surfaces in the polyhedrons having a plurality of surfaces. Further, the retaining jig is configured to retain a plurality of polyhedrons, on which printing can be performed at the same time. At this occasion, the retaining jig retains the plurality of polyhedrons by adjacently arranging one print target surface of each of the plurality of polyhedrons to each other, and bringing the boundaries of the adjacent print target surfaces into contact so that the print target surfaces for printing the print data are formed from the surfaces of the plurality of polyhedrons, where the print data is identical to the print data to be printed on the print target surfaces of one polyhedron.

That is, by using such a retaining jig, one of the print target surfaces of each of the polyhedrons is combined with each other to be arranged adjacently to correspond to the print target surfaces of one polyhedron. Due to this, the print data identical to the print data to be printed on one polyhedron can be printed on the print target surfaces configured by adjacently arranging the surfaces of the plurality of polyhedrons. Further, after having performed the printing of the print data for the first time, the positions of the respective polyhedrons are switched so that surfaces that are not yet printed among the print target surfaces of the respective polyhedrons are combined to correspond to the print target surfaces in one polyhedron and be arranged adjacently. Further, the print data is then again printed on the print target surfaces configured of the surfaces of the plurality of polyhedrons of which positions have been switched.

By repeating such position switch of the polyhedrons and printing until printing is performed on all of the print target surfaces of the respective polyhedrons, the same print data can be printed on the print target surfaces configured of the plurality of adjacent surfaces in each of the plurality of polyhedrons. At this occasion, by causing the retaining jig to retain the same number of polyhedrons as the number of surfaces configuring the print target surfaces, printing can be performed efficiently on the plurality of polyhedrons simply by print processing by the same number as the number of the polyhedrons.

Moreover, since the printing is performed while the print target surfaces of the plurality of polyhedrons are adjacently arranged and the boundaries of the adjacent print target surfaces are brought into contact, the print data that can be obtained by printing on one surface at a time on the print target surfaces in the case of printing continuous print data on the print target surfaces configured of the adjacent three surfaces is connected without any disconnection. Accordingly, polyhedrons having the continuous print data printed on the three surfaces can be obtained efficiently.

Preferably, the retaining jig according to the present invention has a retaining surface for retaining each of the plurality of polyhedrons, wherein the polyhedrons are retained by bringing the retaining surface into contact with one of the surfaces of each polyhedron, and the boundaries of the adjacent print target surfaces are brought into contact by adjacently arranging the one of the print target surfaces of the polyhedron retained by each of the retaining surfaces, so that the print target surfaces for printing the print data are formed by the surfaces of the plurality of polyhedrons.

According to the above configuration, the retaining jig includes the retaining surfaces, and is configured to retain the polyhedrons by bringing the retaining surfaces into contact with one of the surfaces of the polyhedrons to be retained. Further, in the retaining jig, since the retaining surfaces are provided adjacently, by setting the shape of the retaining surfaces in accordance with shapes of the polyhedrons, the print target surfaces of the respective polyhedrons can be arranged adjacently to make their boundaries make contact, and form the print target surfaces corresponding to the print target surfaces of one polyhedron from the surfaces of the plurality of polyhedrons simply by retaining the polyhedrons on the retaining surfaces.

Moreover, as described above, since the retaining jig has a configuration that adjacently arranges the retaining surfaces, design of the retaining jig is easy, and such a retaining jig can be manufactured at low cost.

The retaining jig according to the present invention preferably further includes a fixing unit that is provided to face the retaining surfaces, and sandwiches the polyhedrons between itself and the retaining surfaces to fix the polyhedrons, wherein the fixing unit has its one end coupled to a coupling section, and is configured to be capable of moving in a direction separating away from the retaining surfaces with the coupling section as an axis.

According to the above configuration, the polyhedrons can be fixed to the retaining surfaces by sandwiching the polyhedrons between the fixing unit provided to face the retaining surfaces and the retaining surfaces. Further, the fixing unit has its one end coupled to the coupling section, and is configured to be capable of moving in the direction separating away from the retaining surfaces with the coupling section as the axis. That is, the fixing unit is configured to be capable of being opened and closed relative to the retaining surfaces.

Accordingly, the fixing unit can be moved in the direction separating away from the retaining surfaces to insert the polyhedrons between the retaining surfaces and the fixing unit, and the polyhedrons can easily be fixed between the retaining surfaces and the fixing unit by moving the fixing unit in the direction approaching toward the retaining surfaces. Further, when the polyhedrons are to be taken out, the polyhedrons can easily be taken out by moving the fixing unit in the direction separating away from the retaining surfaces.

In the retaining jig according to the present invention, preferably three retaining surfaces are provided so that a second retaining surface and a third retaining surface are facing each other and coupled to lateral side surfaces of a first retaining surface at a center, and the three polyhedrons are retained such that a first surface in the polyhedron retained on the first retaining surface, that is oppositely facing a surface that makes contact with the first retaining surface, a second surface in the polyhedron retained on the second retaining surface, that is adjacent to a surface at a position corresponding to the first surface, and a third surface in the polyhedron retained on the third retaining surface, that is oppositely facing a surface at a position corresponding to the second surface, are adjacently arranged so that boundaries of adjacent surfaces are brought into contact, and the print target surfaces for printing the print data is formed from the surfaces of the three polyhedrons.

According to the above configuration, the retaining jig includes the three retaining surfaces in which the second retaining surface and the third retaining surface are coupled to the lateral side surfaces of the first retaining surface at the center, so that the second retaining surface and the third retaining surface are facing each other, and are configured to retain the polyhedrons. That is, the retaining jig is configured by coupling the first retaining surface, the second retaining surface, and the third retaining surface in a U shape, and is provided in the shape of an inverted U shape so that the first retaining surface being the bottom of the U shape comes to be the top surface.

With the retaining surfaces being provided as above, the polyhedron can be retained on the first retaining surface by bringing a surface oppositely facing the first surface of the polyhedron into contact with the first retaining surface so that the first surface being the print target surface of the polyhedron is exposed. Further, the polyhedron can be retained on the second retaining surface positioned on the lateral side of the first retaining surface by bringing the surface oppositely facing the first surface of the polyhedron into contact with the second retaining surface so that the second surface adjacent to the first surface is exposed. Further, the polyhedron can be retained on the third retaining surface positioned on the lateral side of the first retaining surface and facing the second retaining surface by bringing the surface oppositely facing the first surface of the polyhedron into contact with the third retaining surface so that the third surface adjacent to the first surface and oppositely facing the second surface is exposed. That is, the retaining jig is configured to retain three polyhedrons by arranging one of the first surface, the second surface, and the third surface of each of the three polyhedrons adjacent to each other, and bringing the boundaries of the adjacent surface into contact so as to form the print target surfaces from these three surfaces.

As above, if one print target surface is selected from each of the three polyhedrons, they are arranged adjacently to bring their boundaries into contact and combined, and the print data identical to the print data to be printed on the print target surfaces of one polyhedron is printed, one of the print target surfaces is printed in each polyhedron. Further, if the position to retain each polyhedron is switched, one of remaining two surfaces on which printing has not yet been performed in each polyhedron is selected, these are adjacently arranged so as to be combined by bringing their boundaries into contact, and printing is performed for the same print data as above, a state in which printing has been performed on two of the print target surfaces in each polyhedron is assumed. Finally, the remaining one surface on which printing has not yet been performed in each polyhedron is selected, these are adjacently arranged so as to be combined by bringing their boundaries into contact, and the positions to retain the respective polyhedrons are switched so as to correspond to the print target surfaces of a single polyhedron. Then, printing is performed on all of the print target surfaces of each polyhedron by performing printing of the same print data as above on the print target surfaces formed by switching the position of each polyhedron.

As above, according to the retaining jig, printing on the print target surfaces configured of the adjacent three surfaces can be performed efficiently for the polyhedrons. Further, since the printing is performed while the print target surfaces of the plurality of polyhedrons are adjacently arranged and the boundaries of the adjacent print target surfaces are brought into contact, the print data that can be obtained by printing on one surface at a time on the print target surfaces in the case of printing continuous print data on the print target surfaces configured of the adjacent three surfaces is connected without any disconnection. Accordingly, polyhedrons having the continuous print data printed on the three surfaces can be obtained efficiently.

The retaining jig according to the present invention preferably includes fixing units that fixe the polyhedrons to each of the second retaining surface and the third retaining surface, wherein each fixing unit is provided to sandwich the polyhedron between itself and the second retaining surface or the third retaining surface.

According to the above configuration, the polyhedrons can be fixed to the second retaining surface and the third retaining surface by sandwiching the polyhedron between the second retaining surface and the fixing unit, and sandwiching the polyhedron between the third retaining surface and the fixing unit. Further, as for the first retaining surface, the polyhedron can be retained simply by mounting the polyhedron thereon.

A print device according to the present invention is characteristic in being provided with any one of the aforementioned retaining jigs. According to the above configuration, similar effects as the aforementioned retaining jig can be obtained.

A print method according to the present invention is a print method for printing print data on print target surfaces that are configured of a plurality of adjacent surfaces in polyhedrons retained in any one of the aforementioned retaining jigs, and including: a first retaining step that retains the plurality of polyhedrons on the retaining jig such that the one of the print target surfaces in each of the plurality of the polyhedrons is arranged adjacent to each other, the boundaries of the adjacent print target surfaces are brought into contact, and the print target surfaces for printing the print data are formed by the surfaces of the plurality of polyhedrons; a first printing step that prints the print data on the print target surfaces configured of the surfaces of the plurality of polyhedrons retained in the retaining jig; a second retaining step that retains, by switching positions of the plurality of polyhedrons within the retaining jig, so that a surface that is different from the printed surface in each of the plurality of polyhedrons is arranged adjacent to each other, the boundaries of the adjacent surfaces are brought into contact, and the print target surfaces for printing the print data are formed from the surfaces of the plurality of polyhedrons; and a second printing step that prints the print data on the print target surfaces configured of the surfaces of the plurality of polyhedrons retained after having switched the positions, wherein the second retaining step and the second printing step are repeated until printing is performed on all of the print target surfaces in each of the plurality of polyhedrons.

According to the above configuration, firstly, in the first retaining step, the plurality of polyhedrons is retained in the retaining jig. At this occasion, the plurality of polyhedrons is retained by adjacently arranging one print target surface of each of the plurality of polyhedrons, and bringing the boundaries of the adjacent print target surfaces into contact so that the print target surfaces for printing the print data are formed from the surfaces of the plurality of polyhedrons, where the print data is identical to the print data to be printed on one polyhedron. Next, in the first printing step, the print data is printed on the print target surfaces configured of the surfaces of the plurality of polyhedrons retained in the first retaining step. Due to this, printing is performed on the first ones of the surfaces among the print target surfaces in the respective polyhedrons.

Further, in the second retaining step, the positions of the polyhedrons are switched in the retaining jig and retained such that a surface different from the printed surface as above is arranged adjacently in the polyhedrons, the boundaries of the adjacent print target surfaces are brought into contact, and the print target surfaces for printing the print data similar to the first printing step is formed. Next, in the second printing step, the print data identical to the first printing step is printed on the print target surfaces configured of the surfaces of the plurality of polyhedrons retained by the positions having been switched in the second retaining step. Due to this, printing is performed on the second ones of the surfaces among the print target surfaces in the respective polyhedrons.

As above, by repeating such printing by switching the positions of the polyhedrons and retaining the same in the retaining jig so that the print target surfaces for printing the print data are formed by the surfaces different from the already-printed surfaces until the print data is printed on all of the print target surfaces of the respective polyhedrons, the printing onto the plurality of polyhedrons can be performed efficiently.

A print method according to the present invention is a print method to print the print data on the print target surfaces that are configured of the three surfaces, namely the first surface, and the second surface and the third surface that are adjacent to the first surface and facing each other, in the polyhedrons retained in the retaining jig provided with three retaining surfaces, the method including: a first printing step that prints the print data on print target surfaces configured of the first surface of a first polyhedron retained on the first retaining surface, the second surface of a second polyhedron retained on the second retaining surface, and the third surface of a third polyhedron retained on the third retaining surface, and in which the boundaries of the adjacent surfaces make contact; a second printing step that prints, after the first printing step, the print data on print target surfaces configured of the first surface of the second polyhedron retained on the first retaining surface, the second surface of the third polyhedron retained on the second retaining surface, and the third surface of the first polyhedron retained on the third retaining surface, and in which the boundaries of the adjacent surfaces make contact; and a third printing step that prints, after the second printing step, the print data on print target surfaces configured of the first surface of the third polyhedron retained on the first retaining surface, the second surface of the first polyhedron retained on the second retaining surface, and the third surface of the second polyhedron retained on the third retaining surface, and in which the boundaries of the adjacent surfaces make contact.

According to the above configuration, the three polyhedrons are retained on the retaining jig, and the printing of the print data is performed on the print target surfaces configured of the three surfaces, namely the first surface, and the second surface and the third surface that are adjacent to the first surface and facing each other, in the polyhedrons. In this print method, firstly, in the first printing step, the print data is printed on the print target surfaces configured of the first surface of the first polyhedron retained on the first retaining surface, the second surface of the second polyhedron retained on the second retaining surface, and the third surface of the third polyhedron retained on the third retaining surface, and in which the boundaries of the adjacent surfaces make contact. Due to this, in the three polyhedrons, printing is performed on first ones of the surface among the print target surfaces configured of the three surfaces.

In the second printing step after the first printing step, the print data is printed on the print target surfaces configured of the first surface of the second polyhedron retained on the first retaining surface, the second surface of the third polyhedron retained on the second retaining surface, and the third surface of the first polyhedron retained on the third retaining surface, and in which the boundaries of the adjacent surfaces make contact. Due to this, in the three polyhedrons, printing is performed on second ones of the surface among the print target surfaces configured of the three surfaces.

Then, in the third printing step after the second printing step, the print data is printed on the print target surfaces configured of the first surface of the third polyhedron retained on the first retaining surface, the second surface of the first polyhedron retained on the second retaining surface, and the third surface of the second polyhedron retained on the third retaining surface, and in which the boundaries of the adjacent surfaces make contact. Due to this, in the three polyhedrons, printing is performed on third ones of the surfaces among the print target surfaces configured of the three surfaces. That is, in each of the three polyhedrons, printing is performed on all of the three surface print target surfaces.

As above, the printing on the print target surfaces configured of the adjacent three surfaces and in which the boundaries of the adjacent surfaces make contact can be performed efficiently for the polyhedrons. Further, since the printing is performed while the print target surfaces of the plurality of polyhedrons are adjacently arranged and the boundaries of the adjacent surfaces are brought into contact, the print data that can be obtained by printing on one surface at a time on the print target surfaces in the case of printing continuous print data on the print target surfaces configured of the adjacent three surfaces is connected without any disconnection. Accordingly, polyhedrons having the continuous print data printed on the three surfaces can be obtained efficiently.

The retaining jig according to the present invention preferably further includes an opening and closing unit that moves the fixing unit in a direction along which a distance from the retaining surfaces change with the coupling section as the axis. Due to this, the fixing unit can easily be opened and closed relative to the retaining surface.

### Effects of the Invention

The retaining jig, the print device, and the print method according to the present invention retain a plurality of polyhedrons upon printing print data on the print target surfaces formed of a plurality of adjacent surfaces in the polyhedrons, such that one of the print target surfaces in each of the plurality of the polyhedrons is arranged adjacently to each other, the boundaries of the adjacent print target surfaces are brought into contact, and the print target surfaces for printing the print data are formed by the surfaces of the plurality of polyhedrons, so printing can be performed on the plurality of polyhedron efficiently.

### BRIEF DESCRIPTION OF THE DRAWINGS

FIG. 1 is a perspective view schematically showing a retaining jig of one embodiment according to the present invention.

FIG. 2 is a perspective view schematically showing the retaining jig of one embodiment according to the present invention.

FIG. 3 is a front view schematically showing the retaining jig of one embodiment according to the present invention.

FIG. 4 is a perspective view schematically showing a print device of one embodiment according to the present invention.

FIG. 5 is a perspective view schematically showing a print device of another embodiment of the present invention.

FIG. 6 is a front view showing one example of opening and closing mechanisms of fixing sections in the retaining jig of one embodiment according to the present invention.

FIG. 7 is a top view showing one example of the opening and closing mechanisms of the fixing sections of the retaining jig of one embodiment according to the present invention.

FIG. 8 is a front view showing another example of opening and closing mechanisms of fixing sections in the retaining jig of one embodiment according to the present invention.

FIG. 9 is a front view showing another example of the opening and closing mechanisms of the fixing sections in the retaining jig of one embodiment according to the present invention.

FIG. 10 is a front view showing another example of opening and closing mechanisms of fixing sections in the retaining jig of one embodiment according to the present invention.

### EMBODIMENTS OF THE INVENTION

### [Retaining Jig]

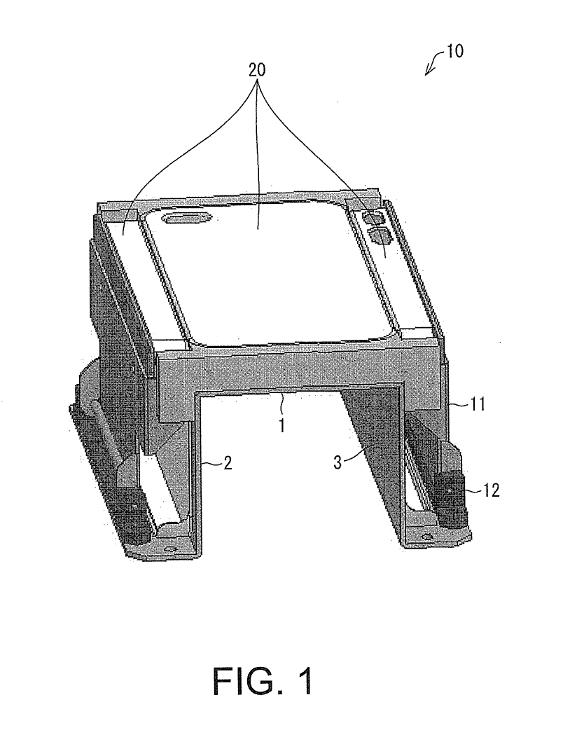

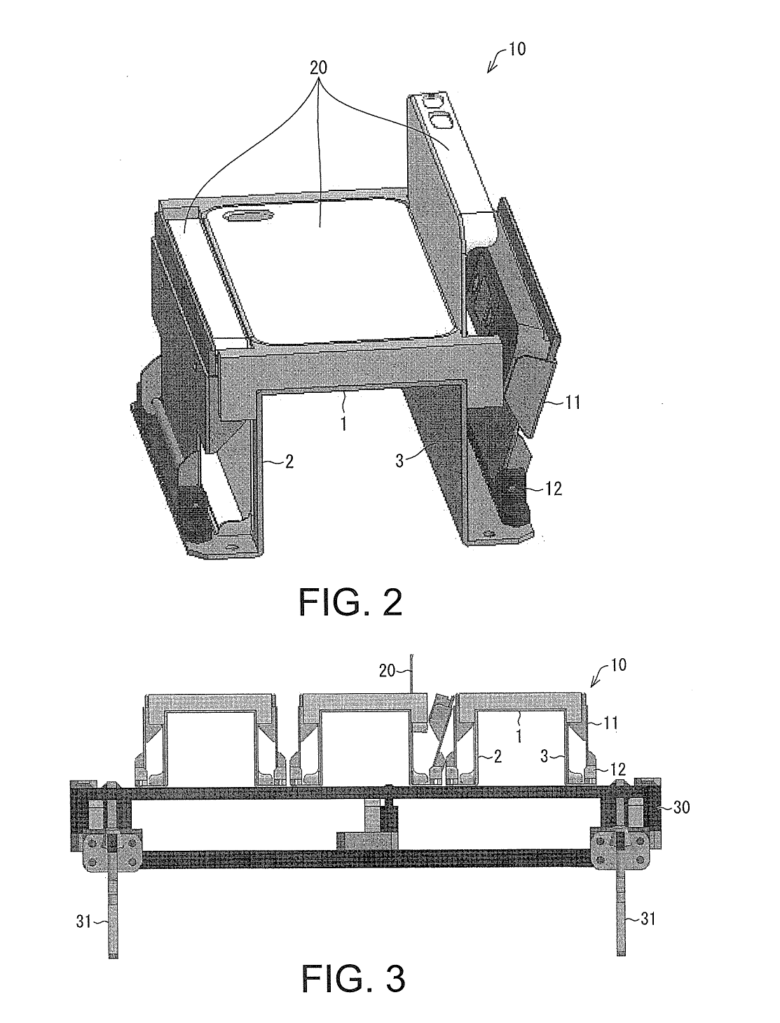

A retaining jig of one embodiment according to the present invention will be described with reference to FIGS. 1 to 3. FIGS. 1 and 2 are perspective views that schematically show a retaining jig of one embodiment according to the present invention, and FIG. 3 is a front view schematically showing the retaining jig of one embodiment according to the present invention.

As shown in FIG. 1, a retaining jig 10 retains a polyhedron upon printing print data on print target surfaces configured of a plurality of adjacent surfaces in the polyhedron. In the present embodiment, as the polyhedron, a case of using a portable terminal casing 20 including one surface, and two surfaces surrounding the same and facing each other will be described as an example. The portable terminal casing 20 has a position corresponding to a display surface of a portable terminal such as a cell phone, a smart phone and the like to be housed therein opened, and includes surfaces that cover lateral side surfaces and a back surface of the display surface. The polyhedron that the retaining jig 10 retains is not limited to the portable terminal casing 20, and there is no specific limitation so long as it is a three-dimensional object having print target surfaces configured of a plurality of adjacent surfaces.

In the present embodiment, the description will be given on an example of a case of printing print data by using the retaining jig 10 on a surface (first surface) on a back surface side of the display surface of the portable terminal to be housed and two surfaces (second surface and third surface) facing each other on lateral sides thereof in the portable terminal casing 20, that is, on print target surfaces that are configured of three adjacent surfaces of the portable terminal casing 20, however, the present invention is not limited hereto. For example, a case of printing print data on print target surfaces configured of five adjacent surfaces for a portable terminal casing 20 configured of a first surface and four lateral side surfaces by using the retaining jig is also included in the scope of the present invention.

The retaining jig 10 retains the portable terminal casings 20 such that print target surfaces for printing the print data are formed from surfaces of the plurality of portable terminal casings 20 by adjacently arranging one of the print target surfaces in each of the plurality of portable terminal casings 20 so that boundaries of the respective surfaces make contact. In the present embodiment, the retaining jig 10 retains the portable terminal casings 20 by adjacently arranging one of the print target surfaces of each of the three portable terminal casings 20 so that the boundaries of the respective surfaces make contact, whereby the print target surfaces configured of three surfaces is formed. As above, the retaining jig 10 retains three portable terminal casings 20, and enables printing on all of them at the same time.

The retaining jig 10 includes the same number of retaining surfaces for retaining the portable terminal casings 20 being arranged adjacently as the number of the portable terminal casings 20 to be retained. In the present embodiment, to retain the three portable terminal casings 20, the retaining jig 10 includes three retaining surfaces, namely a retaining surface (first retaining surface) 1, a retaining surface (second retaining surface) 2, and a retaining surface (third retaining surface) 3. Notably, each of the retaining surfaces 1 to 3 may be configured of one surface, or may be configured of a plurality of surfaces being level with each other.

The retaining surfaces 1 to 3 are coupled so that the retaining surface 2 and the retaining surface 3 are coupled to lateral sides of the retaining surface 1 at a center and facing each other. As shown in FIG. 1, the retaining surfaces 1 to 3 are configured by being coupled in a U-shape. In the retaining jig 10, the retaining surfaces 1 to 3 are provided in a shape of an inverted U shape so that the retaining surface 1 to be a bottom of the U shape becomes the upper surface.

The retaining jig 10 retains first one of the portable terminal casings 20 (first polyhedron) by mounting the portable terminal casing 20 on the retaining surface 1. At this occasion, the retaining jig 10 retains the portable terminal casing 20 by bringing a surface oppositely facing the first surface of the portable terminal casing 20 into contact with the retaining surface 1 so that the first surface of the portable terminal casing 20 is exposed. Moreover, the retaining jig 10 retains a portable terminal casing 20 by bringing a surface oppositely facing the first surface of second one of the portable terminal casings 20 (second polyhedron) into contact with the retaining surface 2. Due to this, a second surface adjacent to the first surface of the portable terminal casing 20 is exposed, and this second surface and the first surface of the portable terminal casing 20 retained on the retaining surface 1 are arranged adjacently with their boundaries making contact.

Further, the retaining jig 10 retains a portable terminal casing 20 on the retaining surface 3 by bringing a surface oppositely facing the first surface of third one of the portable terminal casings 20 (third polyhedron) into contact. Due to this, a third surface that is arranged adjacent to the first surface of the portable terminal casing 20 and oppositely facing the second surface is exposed, and this third surface and the first surface of the portable terminal casing 20 retained on the retaining surface 1 are arranged adjacently with their boundaries making contact.

That is, in the retaining surface 1, a length in a direction sandwiched between the retaining surface 2 and the retaining surface 3 is caused to match a length of the first surface of the portable terminal casing 20 in a direction sandwiched between the second surface and the third surface. Further, heights of the retaining surfaces 2 and 3 are set to a length that is obtained by subtracting a width of the portable terminal casing 20, that is, a length of the second surface and the third surface in a direction intersecting the first surface from a length of the first surface of the portable terminal casing 20 in the direction sandwiched between the second surface and the third surface. Due to this, an exposed surface of each of the portable terminal casings 20 is arranged adjacently by having the boundaries make contact when the portable terminal casings 20 are retained by the retaining surfaces 1 to 3, and the leveled print target surfaces are formed thereby.

In the retaining jig 10, the retaining surfaces 1 to 3 are provided by being arranged adjacently, so the print target surfaces of the respective portable terminal casings 20 can be adjacently arranged by having their boundaries make contact by simply retaining the portable terminal casings 20 by the retaining surfaces 1 to 3, by setting the shapes of the retaining surfaces 1 to 3 in accordance with the shapes of the portable terminal casings 20. Further, since retaining positions of the portable terminal casings 20 are clearly positioned, leveled print target surfaces can easily be formed. Moreover, since the retaining jig 10 has a configuration that adjacently arranges the retaining surfaces 1 to 3, design of the retaining jig 10 is easy, and such a retaining jig 10 can be manufactured at low cost.

By having the portable terminal casings 20 retained by such a retaining jig 10, one of the first surface, the second surface, and the third surface of each of the three portable terminal casings 20 can be arranged adjacently, whereby the leveled print target surfaces in which the boundaries of these three surfaces make contact can be formed. Further, by printing the print data, which is to be printed on the print target surfaces configured of the first surface, the second surface, and the third surface of one portable terminal casing 20, on the print target surfaces formed as above, printing is performed on one of the print target surfaces for each of the three portable terminal casings 20.

Further, in the retaining jig 10, if a position to retain each portable terminal casing 20 is switched, one of remaining two surfaces to which printing has not yet been performed in each portable terminal casing 20 is selected, these are adjacently arranged so as to be combined by bringing their boundaries into contact, and the same print data as above is printed, a state in which two of the print target surfaces are printed in each portable terminal casing 20 is assumed. Finally, the remaining one surface to which printing has not yet been performed in each portable terminal casing 20 is selected, these are adjacently arranged so as to be combined by bringing their boundaries into contact, and the positions to retain the portable terminal casings 20 are switched so as to correspond to the print target surfaces of a single portable terminal casing 20. Further, printing is performed on all of the print target surfaces of each portable terminal casing 20 by printing the same print data as above on the print target surfaces formed by switching the position of each portable terminal casing 20.

As above, by using the retaining jig 10, printing on the print target surfaces configured of the three surfaces, namely the first surface to the third surface, of the respective portable terminal casings 20 can be performed efficiently by printing on the plurality of portable terminal casings 20 at the same time. Further, since the printing is performed while adjacently arranging the print target surfaces of the three portable terminal casings 20 respectively and bringing the boundaries thereof into contact with each other, the print data that can be obtained by printing on each surface of the print target surfaces in printing continuous print data on the print target surfaces configured of three surfaces, namely of the first surface to the third surface is connected without any disconnection. Accordingly, portable terminal casings 20 having the continuous print data printed on the three surfaces can be obtained efficiently.

As shown in FIG. 2, the retaining jig 10 includes fixing sections (fixing units) 11 that fix the portable terminal casings 20 to the retaining surface 2 and the retaining surface 3 respectively. Each fixing section 11 is provided so as to sandwich the portable terminal casing 20 between itself and the retaining surface 2 or the retaining surface 3.

Each fixing section 11 has its one end connected to a bottom surface of the retaining jig 10 by a coupling section 12 at a position that faces the retaining surface 2 or 3. Further, each fixing section 11 is provided to be capable of moving in a direction separating away from the retaining surface 2 or 3 with the coupling section 12 as an axis.

In the present embodiment, the coupling section 12 is configured to be rotatable, and the fixing section 11 can be opened or closed relative to the retaining surface 2 or 3 by moving an end of the fixing section 11 that is not coupled to the coupling section 12 in the direction separating away from or approaching toward the retaining surface 2 or 3. Notably, the fixing section 11 may be configured to be capable of opening and closing relative to the retaining surface 2 or 3 by sliding the fixing section 11 with the coupling section 12 as the axis, however, it is preferable to configure the coupling section 12 to be rotatable since the opening and closing of the fixing section 11 can be performed more stably.

In the present embodiment, the portable terminal casing 20 can be inserted between the retaining surface 3 and the fixing section 11 as shown in FIG. 2 by opening the fixing section 11 in the direction separating away from the retaining surface 3. Further, after having inserted the portable terminal casing 20 between the retaining surface 3 and the fixing section 11, the portable terminal casing 20 can be retained on the retaining surface 3 by closing the fixing section 11 in the direction approaching toward the retaining surface 3. Further, when the portable terminal casing 20 is to be taken out, the portable terminal casing 20 can easily be taken out by opening the fixing section 11 in the direction separating away from the retaining surface 2 or 3.

As above, since the fixing sections 11 that fix the portable terminal casings 20 to the retaining surface 2 or 3 are provided, space can be saved in a width direction compared to a case of fixing the portable terminal casings 20 to the retaining surface 2 or 3 manually, upon performing printing by arranging the retaining jigs 10 in the width direction as shown in FIG. 3 to be described later.

Moreover, magnets may be provided on surfaces of the fixing sections 11 facing the retaining surface 2 or 3, and the retaining surface 2 or 3 may be configured of a ferromagnetic body such as iron and the like, so that the portable terminal casings 20 may be firmly fixed between the fixing sections 11 and the retaining surface or the retaining surface 3.

In printing on the portable terminal casings 20 retained in the retaining jigs 10, as shown in FIG. 3, a plurality of retaining jigs 10 may be arranged on a retaining jig tray 30, and the retaining jig tray 30 may be provided in the print device. In FIG. 3, there are three retaining jigs 10 arranged in a left and right direction of the drawing, and the retaining jig 10 at the center shows a state in which the fixing section 11 facing the retaining surface 3 is opened in the direction separating away from the retaining surface 3.

As described above, the retaining jig 10 retains a plurality of portable terminal casings 20 upon printing print data on the print target surfaces configured of the plurality of adjacent surfaces of the portable terminal casings 20, by adjacently arranging the one of the print target surfaces in each of the plurality of portable terminal casings 20, bringing the boundaries of the adjacent print target surfaces into contact, and forming the print target surfaces for printing the print data from the surfaces of the plurality of portable terminal casings 20. Accordingly, the print data can be printed efficiently on the plurality of portable terminal casings 20 by printing on the portable terminal casings 20 retained in the retaining jig 10.

### [Print Device]

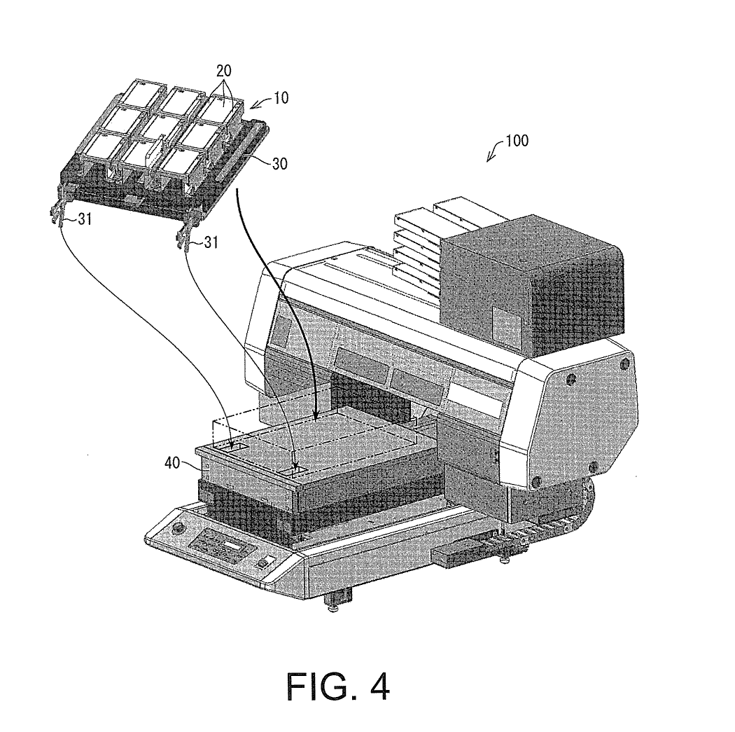

The print device according to the present invention is characteristic in being provided with the retaining jig according to the present invention. The print device of one embodiment according to the present invention will be described with reference to FIG. 4. As shown in FIG. 4, a print device 100, in which a retaining jig tray 30 provided by having the plurality of retaining jigs 10 arranged therein is installed, prints predetermined print data on the plurality of portable terminal casings 20 retained in the retaining jigs 10. The retaining jig tray 30 is installed in the print device 100 by inserting an attachment metal fitting 31 provided at a lower part of the retaining jig tray 30 as show in FIG. 3 into an engagement portion provided on a table 40 of the print device 100.

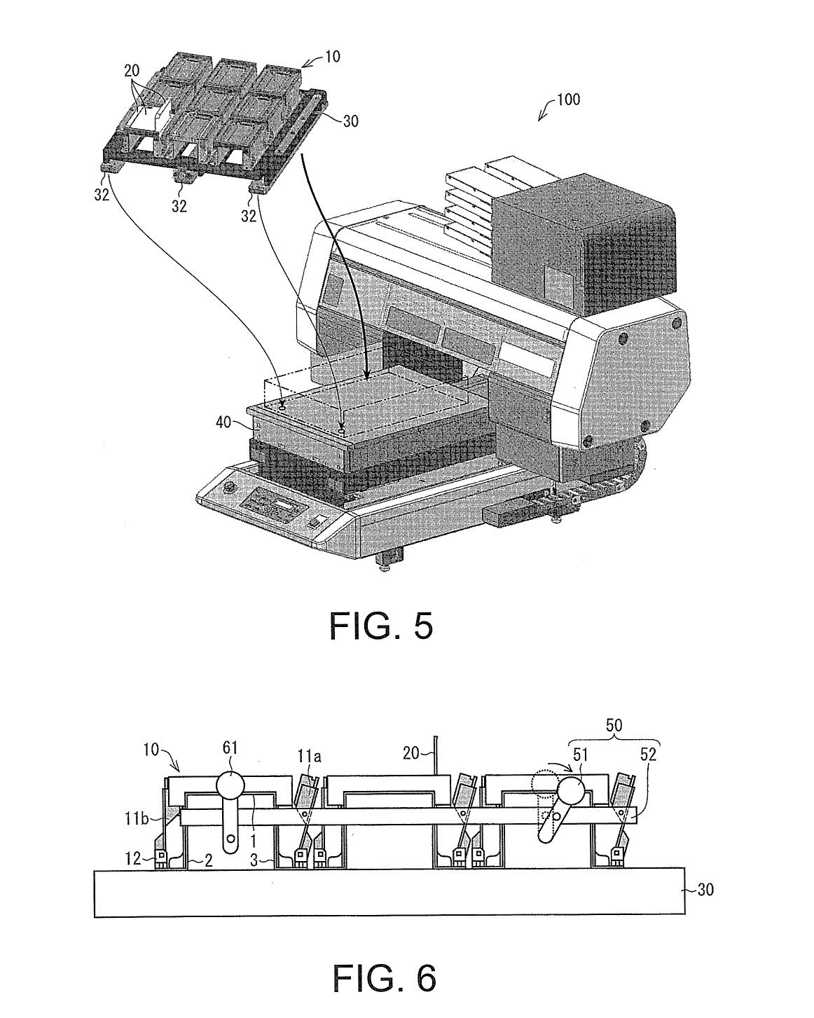

Moreover, as shown in FIG. 5, the print device 100 may be configured such that the retaining jig tray 30 is mounted on the table 40 to overlap a screw hole formed in an attachment section 32 provided at the lower part of the retaining jig tray 30 and a screw hole provided in the table 40 and tighten the same with a bolt or the like. Notably, in FIG. 5, an example in which the attachment section 32 at a center is used for positioning, and attachment sections 32 on left and right sides are for screw fixing the retaining jig tray 30 onto the table 40 is described, however, the attachment section 32 at the center may be provided with a screw hole as well to have the same configuration as the attachment sections 32 on the left and right sides. Moreover, in FIG. 5, the screw holes are provided only at two portions in the retaining jig tray 30 and the table 40, respectively, however, the screw holes may be provided at four portions in the retaining jig tray 30 and the table 40 so that four corners are screw-fixed.

Since one embodiment that realizes the retaining jig of the print device according to the present invention print device is the retaining jig 10, the details of one embodiment of the print device according to the present invention print device is similar to the description of the retaining jig according to the present invention as described above.

### [Print Method]

A print method according to the present invention is a print method for printing print data on the print target surfaces configured of a plurality of adjacent surfaces in the polyhedrons retained by the retaining jig according to the present invention. The print method of one embodiment according to the present invention includes a first retaining step, a first printing step, a second retaining step, and a second printing step. In the present embodiment, the case of printing print data on the print target surfaces configured of the three surfaces, namely the first to third surfaces, of the portable terminal casings 20 retained by the retaining jig 10 will be described as an example.

### (First Retaining Step)

In the first retaining step, the retaining jig 10 is caused to retain three portable terminal casings 20 such that one of the print target surfaces of the each of the three portable terminal casings 20 is adjacently arranged and the boundaries of the adjacent print target surfaces are brought into contact, so that the print target surfaces configured of the surfaces of the three portable terminal casings 20 are formed.

That is, the first portable terminal casing (first polyhedron) 20 is retained on the retaining surface 1 so that its first surface is exposed, the second portable terminal casing (second polyhedron) 20 is retained on the retaining surface 2 so that its second surface is exposed, and the third portable terminal casing (third polyhedron) 20 is retained on the retaining surface 3 so that its third surface is exposed. Due to this, the first to third surfaces are arranged adjacently, and the leveled print target surfaces in which the respective boundaries make contact are formed.

### (First Printing Step)

In the first printing step, the print data is printed on the print target surfaces, which is configured of the surfaces of the three portable terminal casings 20 retained by the retaining jig 10 in the first retaining step and in which the respective boundaries make contact. Due to this, printing is performed on the first ones of the surfaces among the print target surfaces configured of the three surfaces in each portable terminal casing 20. That is, printing is performed on the first surface of the first portable terminal casing 20, the second surface of the second portable terminal casing 20, and the third surface of the third portable terminal casing 20.

### (Second Retaining Step)

In the second retaining step, the positions of the portable terminal casings 20 are switched in the retaining jig 10 and retained such that a surface different from the printed surface as above is arranged adjacently in each of the three portable terminal casings 20, the boundaries of the adjacent print target surfaces are brought into contact, and the print target surfaces for printing the print data similar to the first printing step is formed.

That is, the second portable terminal casing 20 is retained on the retaining surface 1 so that its first surface is exposed, the third portable terminal casing 20 is retained on the retaining surface 2 so that its second surface is exposed, and the first portable terminal casing 20 is retained on the retaining surface 3 so that its third surface is exposed. Due to this, the first to third surfaces are arranged adjacently, and the leveled print target surfaces in which the respective boundaries make contact are formed.

### (Second Printing Step)

In the second printing step, the print data that is the same as the first printing step is printed on the print target surfaces configured of the surfaces of the three portable terminal casings 20 of which positions have been switched and retained, and in which the respective boundaries make contact. Due to this, printing is performed on the second ones of the surfaces among the print target surfaces of the portable terminal casings 20. That is, printing is performed on the third surface of the first portable terminal casing 20, the first surface of the second portable terminal casing 20, and the second surface of the third portable terminal casing 20.

### (Third Printing Step)

The third printing step switches the positions of the respective portable terminal casings 20 after the second printing step, so that the print data that is the same as the first printing step and the second printing step is printed on the print target surfaces configured of the first surface of the third portable terminal casing 20 retained on the retaining surface 1, the second surface of the first portable terminal casing 20 retained on the retaining surface 2, and the third surface of the second portable terminal casing 20 retained on the retaining surface 3, and in which the respective boundaries make contact. Due to this, in the three portable terminal casings 20, printing is performed on third ones of the surface among the print target surfaces configured of the three surfaces. That is, printing is performed on the second surface of the first portable terminal casing 20, the third surface of the second portable terminal casing 20, and the first surface of the third portable terminal casing 20, and printing is performed on all of the three print target surfaces in each of the three portable terminal casings 20.

As above, according to the print method of the present embodiment, the printing on the print target surfaces configured of the adjacent three surfaces can be performed efficiently for the portable terminal casings 20. Further, since the printing is performed by adjacently arranging the respective print target surfaces of the plurality of portable terminal casings 20 and bringing the boundaries of the adjacent print target surfaces into contact, the print data obtained by printing on each surface among the print target surfaces in the case of printing continuous print data on the print target surfaces configured of the adjacent three surfaces are connected without any disconnection. Accordingly, portable terminal casings 20 having the continuous print data printed on the three surfaces can be obtained efficiently.

Notably, in the portable terminal casings 20, in a case where the print target surfaces are configured of three or more surfaces, such as in the case of print target surfaces configured of four surfaces, namely the first surface and the lateral side surfaces thereof, similar printing is repeated by further switching the positions of the portable terminal casings 20 after the third printing step, and the retaining step and the printing step are repeated until printing is performed on all of the print target surfaces in each of the plurality of portable terminal casings 20.

According to the print method of the present invention, in the polyhedrons retained by the retaining jig according to the present invention, the print method prints the print data on the print target surfaces configured of the plurality of adjacent surfaces, and printing is performed on all of the print target surfaces of each polyhedron by printing for the same number of times as the number of the print target surfaces while switching the positions of the polyhedrons retained by the retaining jig, so the printing of the print data onto the plurality of polyhedrons can be performed efficiently.

[Opening and closing Mechanism of Fixing Section]

An example of opening and closing mechanisms (opening and closing unit) that open and close the fixing sections 11 provided in the retaining jig 10 will be described below with reference to FIGS. 6 to 10. Each opening and closing mechanism opens and closes the fixing section 11 by moving the fixing section 11 in a direction along which a distance from the retaining surface 2 or 3 changes, with the coupling section 12 as an axis.

### (Opening and Closing Mechanisms 50 and 60)

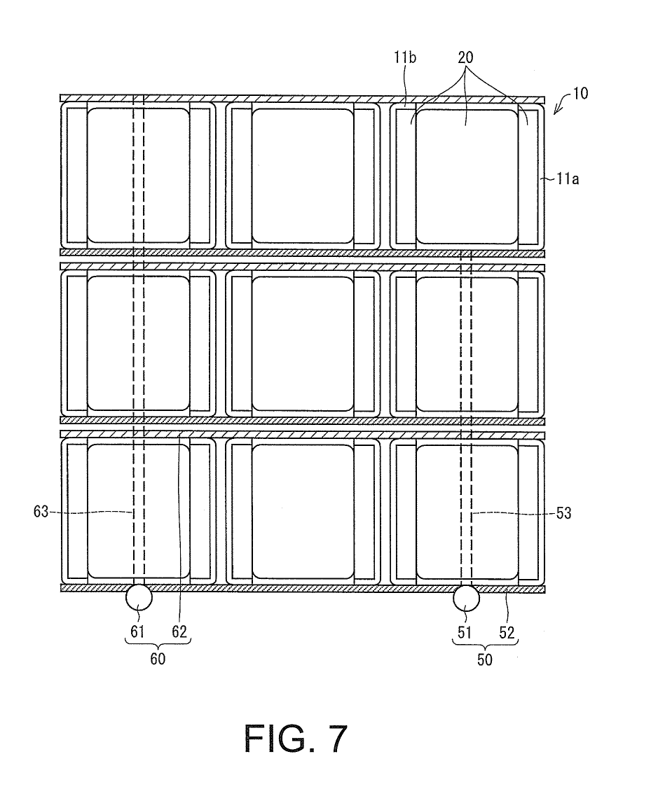

As shown in FIGS. 6 and 7, the retaining jig 10 may include an opening and closing mechanism 50 for opening and closing the fixing sections 11a, and an opening and closing mechanism 60 for opening and closing the fixing sections 11b. FIG. 6 is a front view showing one example of the opening and closing mechanisms of the fixing sections in the retaining jig of one embodiment according to the present invention, and FIG. 7 is a top view showing one example of the opening and closing mechanisms of the fixing sections in the retaining jig of one embodiment according to the present invention.

In the retaining jig 10, the fixing sections 11a and 11b are coupled to the retaining jig 10 by the coupling sections 12 configured to be rotatable. As shown in FIGS. 6 and 7, the retaining jigs 10 are arranged on the retaining jig tray 30 in a plurality of rows. In FIGS. 6 and 7, an example in which the retaining jigs 10 are arranged in a 3 by 3 array is shown, however, the present invention is not limited hereto. The opening and closing mechanism 50 is configured to be capable of opening and closing the fixing sections 11a of all of the retaining jigs 10 arranged on the retaining jig tray 30 at a time, and the opening and closing mechanism 60 is configured to be capable of opening and closing the fixing sections 11b of all of the retaining jigs 10 arranged on the retaining jig tray 30 at a time.

The opening and closing mechanism 50 is configured of a lever 51 that operates the opening and closing of the fixing sections 11a, coupling plates 52 coupled to the fixing sections 11a of the retaining jigs 10 arranged in a transverse direction of FIG. 6 and FIG. 7, and a coupling plate 53 that couples the plurality of coupling plates 52. The coupling plates 52 are configured to be movable in the transverse direction by the lever 51. The lever 51 is configured to cause the coupling plates 52 to move in the same direction when operated in the opening and closing direction of the fixing sections 11a. As above, all of the fixing sections 11a coupled to the coupling plates 52 open accompanying the movement of the coupling plates 52 by operating the lever 51 in the direction to open the fixing sections 11a. Similarly, by operating the lever 51 in the direction to close the fixing sections 11a, all of the fixing sections 11a coupled to the coupling plates 52 close accompanying the movement of the coupling plates 52.

As shown in FIG. 7, the fixing sections 11a of the retaining jigs 10 arranged in another transverse direction on the retaining jig tray 30 are also coupled to another coupling plate 52. Further, the plurality of coupling plates 52 are coupled in a vertical direction of FIG. 7 by the coupling plate 53. Accordingly, when one coupling plate 52 is moved by the lever 51, all the other coupling plates 52 coupled to this coupling plate 52 are moved by the coupling plate 53, and the fixing sections 11a coupled to the other coupling plates 52 can be opened and closed.

Moreover, the opening and closing mechanism 60 is configured of a lever 61 for operating the opening and closing of the fixing sections 11b, coupling plates 62 coupled to the fixing sections 11b of the retaining jigs 10 arranged in the transverse direction of FIG. 7, and a coupling plate 63 that couples the plurality of coupling plates 62. The coupling plates 62 are provided on surfaces that are opposite from surfaces where the coupling plates 52 are provided in the retaining jigs 10; that is, the coupling plates 52 and the coupling plates 62 are arranged to face each other with the retaining jigs 10 in between. Notably, the lever 61 is provided on the same side as the lever 51, and is coupled to the coupling plates 62 such that the coupling plates 62 are movable.

The opening and closing mechanism 60 differs from the opening and closing mechanism 50 only in that the coupling plates 62 are coupled to the fixing sections 11b. Accordingly, the opening and closing mechanism 60 can open and close all of the fixing sections 11b coupled to each of the plurality of coupling plates 52 by operating the lever 61 in the opening and closing direction of the fixing sections 11b.

As above, by providing the opening and closing mechanisms 50 and 60 in the retaining jigs 10, the fixing sections 11a and 11b of the plurality of retaining jigs 10 arranged on the retaining jig tray 30 can be opened and closed at a time.

### (Opening and Closing Mechanism 70)

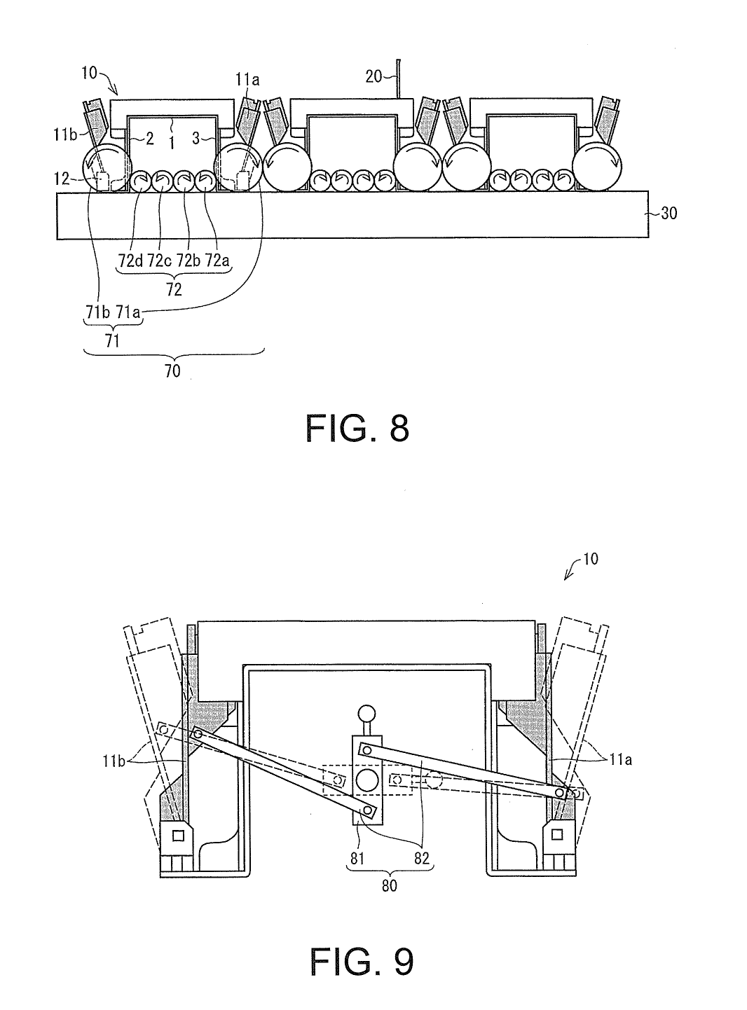

As shown in FIG. 8, the retaining jigs 10 may be provided with an opening and closing mechanism 70 for opening and closing the fixing sections 11a and 11b. FIG. 8 is a front view showing one example of the opening and closing mechanisms of the fixing sections in the retaining jig of one embodiment according to the present invention.

In the retaining jig 10, the fixing sections 11a and 11b are coupled to the retaining jig 10 by the coupling sections 12 configured to be rotatable. As shown in FIG. 8, the retaining jigs 10 are arranged in a plurality of rows on the retaining jig tray 30. In FIG. 8, an example in which three retaining jigs 10 are arranged laterally is shown, however, the present invention is not limited hereto. The opening and closing mechanism 70 is provided to be capable of opening and closing the fixing sections 11a and 11b of all of the retaining jigs 10 arranged in the transverse direction of FIG. 8 at a time.

The opening and closing mechanism 70 is configured of gears 71 and gears 72. The gears 71 are configured of gears 71a coupled to the fixing sections 11a, and gears 71b coupled to the fixing sections 11b. The gears 72 are configured of gears 72a to 72d provided between the gears 71a and the gears 71b. Notably, in FIG. 8, a configuration provided with four gears 72 is shown as an example, however, the present invention is not limited hereto.

The fixing sections 11a are opened by rotating the gears 71a in the direction to open the fixing sections 11a, and the fixing sections 11a are closed by rotating the gears 71a in the direction to close the fixing sections 11a. Moreover, the fixing sections 11b are opened by rotating the gears 71b in the direction to open the fixing sections 11b, and the fixing sections 11b are closed by rotating the gears 71b in the direction to close the fixing sections 11b.

The gears 71 and the gears 72 are provided adjacent to each other, and the gears 72a to 72d are provided adjacent to each other. That is, the gears 71a, the gears 72a to 72d, and the gears 71b are provided adjacent to each other in this order. Accordingly, for example, when the gears 71a are rotated in the direction to open the fixing sections 11a, the gears 72a rotate in directions shown by arrows in FIG. 8 accompanying the rotation of the gears 71a. Further, accompanying the rotation of the gears 72a, the gears 72b, the gears 72c and the gears 72d rotate orderly. The gears 71b rotate in a direction to open the fixing sections 11b accompanying the rotation of the gears 72d. In case of closing the fixing sections 11a and 11b, the respective gears can be rotated so that the gears 71a and 71b rotate in the direction to close the fixing sections 11a and 11b.

As above, both of the gears 71a and 71b rotate by causing one of the gears to rotate, whereby both of the fixing sections 11a and 11b can be opened and closed. Moreover, the gear 71a provided on one retaining jig 10 and the gear 71b provided in another retaining jig 10 that is adjacent are arranged adjacently, and the gear 71b provided in the other retaining jig 10 is rotated accompanying the rotation of the gear 71a. Due to this, the fixing sections 11a and 11b can be opened and closed at a time among adjacent retaining jigs 10.

Notably, the fixing sections 11a and 11b of the retaining jigs 10 arranged in the vertical direction on a backside of the retaining jigs 10 arranged in the transverse direction shown in FIG. 8 may be coupled to the fixing sections 11a and 11b of the retaining jig 10 on the front side so that they are opened and closed in cooperation by the opening and closing mechanism 70 provided for the retaining jigs 10 on the front side.

### (Opening and Closing Mechanism 80)

The retaining jig 10 as shown in FIG. 9 may include an opening and closing mechanism 80 for opening and closing the fixing sections 11a and 11b. FIG. 9 is a front view diagram showing one example of the opening and closing mechanisms of the fixing sections in the retaining jig of one embodiment according to the present invention. In the retaining jig 10, the fixing sections 11a and 11b are coupled to the retaining jig 10 by the coupling sections 12 configured to be rotatable.

The opening and closing mechanism 80 is configured of a rotating section 81 and coupling plates 82. The rotating section 81 has a rectangular shape having long sides and short sides, and is coupled to two coupling plates 82 at respective ends in a long side direction. The rotating section 81 is provided rotatably with a shaft as a center. The coupling plates 82 couple the rotating section 81 and the fixing section 11a or 11b. Connected sections of the rotating section 81 and the coupling plates 82 are configured to be rotatable, and angles of the connected sections of the rotating section 81 and the coupling plates 82 are changed accompanying the rotating movement of the rotating section 81.

When the rotating section 81 is for example rotated so that its long side direction becomes vertical, the connected sections of the rotating section 81 and the coupling plates 82 rotate to pull the fixing sections 11a and 11b by the coupling plates 82 in the closing direction. Further, when the rotating section 81 is rotated so that its long side direction becomes horizontal, the connected sections of the rotating section 81 and the coupling plates 82 rotate to push the fixing sections 11a and 11b by the coupling plates 82 in the opening direction.

As above, by rotating the rotating section 81, both of the fixing sections 11a and 11b can be opened and closed. Notably, the fixing sections 11a and 11b of the adjacent retaining jig 10 may be configured to be opened and closed in cooperation with the fixing sections 11a and 11b of the retaining jig 10 to which the opening and closing mechanism 80 is provided.

Notably, the retaining jigs 10 arranged in the transverse direction of the retaining jigs 10 as shown in FIG. 9 are respectively provided with the opening and closing mechanism 80. Further, the fixing sections 11a and 11b of the retaining jigs 10 arranged on the back side in the vertical direction of the retaining jigs 10 shown in FIG. 9 may be coupled to the fixing sections 11a and 11b of the retaining jigs 10 on the front side, so that they are opened and closed in cooperation with the opening and closing mechanism 80 provided in the retaining jigs 10 arranged on the front side.

### (Opening and Closing Mechanism 90)

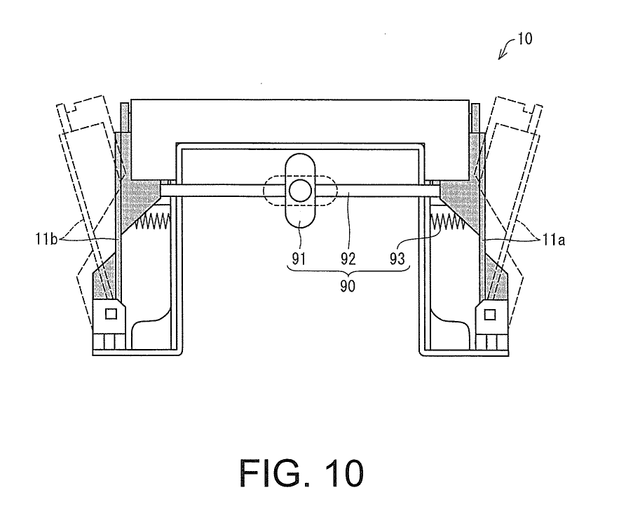

The retaining jig 10 as shown in FIG. 10 may include an opening and closing mechanism 90 for opening and closing the fixing sections 11a and 11b. FIG. 10 is a front view showing one example of the opening and closing mechanisms of the fixing sections in the retaining jig of one embodiment according to the present invention. In the retaining jig 10, the fixing sections 11a and 11b are coupled to the retaining jig 10 by the coupling sections 12 configured to be rotatable.

The opening and closing mechanism 90 is configured of a cam 91, sliding protrusions 92, and springs 93. The sliding protrusions 92 are connected between the cam 91 and the fixing sections 11a and 11b. Angle changing mechanisms are attached at connecting positions of the sliding protrusions 92 and the fixing sections 11a and 11b, so that the sliding protrusions 92 are kept horizontal at all times. Moreover, the springs 93 for biasing toward the direction to close the fixing sections 11a and 11b are provided between the fixing section 11a and the retaining surface 3, and between the fixing section 11b and the retaining surface 2.

The cam 91 is provided rotatably with a shaft as a center, and it can be configured for example of a circular disk or the like of which distance from the shaft to its outer periphery is not constant. When the cam 91 is rotated for example so that its long axis direction becomes vertical, the sliding protrusions 92 move slidingly to pull the fixing sections 11a and 11b in the closing direction. Further, when the cam 91 is rotated so that its long axis direction becomes horizontal, the sliding protrusions 92 move slidingly to push the fixing sections 11a and 11b in the opening direction.

As above, both of the fixing sections 11a and 11b can be opened and closed by rotating the cam 91. Notably, the fixing sections 11a and 11b of the adjacent retaining jig 10 may be configured to open and close in cooperation with the fixing sections 11a and 11b of the retaining jig 10 to which the opening and closing mechanism 90 is provided.

Notably, the retaining jigs 10 arranged in the transverse direction of the retaining jig 10 shown in FIG. 10 are each provided with the opening and closing mechanism 90. Further, the fixing sections 11a and 11b of the retaining jigs 10 arranged on the back side of the retaining jig 10 shown in FIG. 10 in the vertical direction may be coupled to the fixing sections 11a and 11b of the retaining jigs 10 on the front side so that they are opened and closed in cooperation with the opening and closing mechanisms 90 provided in the retaining jigs 10 arranged on the front side.

### [Supplementary Information]

The retaining jig 10 is a retaining jig 10 that retains polyhedrons upon printing print data on print target surfaces formed of a plurality of adjacent surfaces in the polyhedrons, where the plurality of polyhedrons is retained such that one of the print target surfaces in each of the plurality of the polyhedrons is arranged adjacently to each other, boundaries of the adjacent print target surfaces are brought into contact, and the print target surfaces for printing the print data are formed from the surfaces of the plurality of polyhedrons.

According to the above configuration, the retaining jig 10 retains the polyhedrons upon printing the print data on the print target surfaces configured of a plurality of adjacent surfaces in the polyhedrons having the plurality of surfaces. Further, the retaining jig 10 is configured to retain a plurality of polyhedrons, on which printing can be performed at the same time. At this occasion, the retaining jig 10 retains the plurality of polyhedrons by adjacently arranging one print target surface of each of the plurality of polyhedrons to each other, and bringing the boundaries of the adjacent print target surfaces into contact so that the print target surfaces for printing the print data are formed from the surfaces of the plurality of polyhedrons, where the print data is identical to the print data to be printed on the print target surfaces of one polyhedron.

That is, by using such a retaining jig 10, one of the print target surfaces of each of the polyhedrons is combined to be arranged adjacently to correspond to the print target surfaces of one polyhedron, whereby the print data identical to the print data to be printed on one polyhedron can be printed on the print target surfaces configured by adjacently arranging the surfaces of the plurality of polyhedrons. Further, after having performed the printing of the print data for the first time, the positions of the respective polyhedrons are switched so that surfaces that have not yet been printed among the print target surfaces of the respective polyhedrons are combined to correspond to the print target surfaces in one polyhedron and be arranged adjacently. Further, the print data is then again printed on the print target surfaces configured of the surfaces of the plurality of polyhedrons of which positions have been switched.

By repeating such position switch of the polyhedrons and printing until printing is performed on all of the print target surfaces of the respective polyhedrons, the same print data can be printed on the print target surfaces configured of the plurality of adjacent surfaces in each of the plurality of polyhedrons. At this occasion, by causing the retaining jig 10 to retain the same number of polyhedrons as the number of surfaces configuring the print target surfaces, printing can be performed on the plurality of polyhedrons efficiently by the same number of print processing as the number of the polyhedrons.

Moreover, since printing is performed while the print target surfaces of the plurality of polyhedrons are adjacently arranged and the boundaries of the adjacent print target surfaces are brought into contact, the print data that can be obtained by printing on one surface at a time on the print target surfaces in the case of printing continuous print data on the print target surfaces configured of the adjacent three surfaces is connected without any disconnection. Accordingly, polyhedrons having the continuous print data printed on the three surfaces can be obtained efficiently.

The retaining jig 10 has a retaining surface for retaining each of the plurality of polyhedrons, wherein the print target surfaces for printing the print data are formed by the surfaces of the plurality of polyhedrons, such that the polyhedrons are retained by bringing the retaining surface into contact with one of the surfaces of each polyhedron, and the boundaries of the adjacent print target surfaces are brought into contact by adjacently arranging the one of the print target surfaces of the polyhedron retained by each of the retaining surfaces.

According to the above configuration, the retaining jig 10 includes the retaining surfaces, and is configured to retain the polyhedrons by bringing the retaining surfaces into contact with one of the surfaces of the polyhedrons to be retained. Further, in the retaining jigs 10, since the retaining surfaces are provided adjacently, simply by setting the shape of the retaining surfaces in accordance with shapes of the polyhedrons, the print target surfaces of the respective polyhedrons can be arranged adjacently to bring their boundaries into contact, and form the print target surfaces corresponding to the print target surfaces of one polyhedron from the surfaces of the plurality of polyhedrons simply by retaining the polyhedrons on the retaining surfaces.

Moreover, as described above, since the retaining jig 10 has a configuration that adjacently arranges the retaining surfaces, the design of the retaining jig 10 is easy, and such a retaining jig 10 can be manufactured at low cost.

The retaining jigs 10 further include the fixing sections 11 that are provided to face the retaining surfaces, and sandwich the polyhedrons between them and the retaining surfaces and fix the polyhedrons, and the fixing sections 11 have their one ends coupled to the coupling sections 12, and are configured to be capable of moving in the direction separating away from the retaining surfaces with the coupling sections 12 as their axes.

According to the above configuration, the polyhedrons can be fixed to the retaining surfaces by sandwiching the polyhedrons between the fixing sections 11 provided to face the retaining surfaces and the retaining surfaces. Further, the fixing sections 11 have their one ends coupled to the coupling sections 12, and are configured to be capable of moving in the direction separating away from the retaining surfaces with the coupling sections 12 as their axes. That is, the fixing sections 11 are configured to be capable of being opened and closed relative to the retaining surfaces.

Accordingly, the fixing sections 11 can be moved in the direction separating away from the retaining surfaces to insert the polyhedrons between the retaining surfaces and the fixing sections 11, and the polyhedrons can easily be fixed between the retaining surfaces and the fixing sections 11 by moving the fixing sections 11 in the direction approaching toward the retaining surfaces. Further, when the polyhedrons are to be taken out, the polyhedrons can easily be taken out by moving the fixing sections 11 in the direction separating away from the retaining surfaces.

The retaining jigs 10 include the three retaining surfaces 1 to 3 so that the retaining surface 2 and the retaining surface 3 are facing each other and coupled to lateral side surfaces of the retaining surface 1 at the center, and are configured to each retain the three portable terminal casings 20 such that the first surface in the portable terminal casing 20 retained on the retaining surface 1 that oppositely faces the surface making contact with the retaining surface 1, the second surface in the portable terminal casing 20 retained on the retaining surface 2, that is adjacent to the surface at the position corresponding to the first surface, and the third surface in the portable terminal casing 20 retained on the retaining surface 3, that is oppositely facing the surface at the position corresponding to the second surface, are adjacently arranged so that the boundaries of the adjacent surfaces are brought into contact, and the print target surfaces for printing the print data is formed from the surfaces of the three portable terminal casings 20.

According to the above configuration, the retaining jigs 10 include the three retaining surfaces 1 to 3 in which the retaining surface 2 and the retaining surface 3 are coupled to the lateral side surfaces of the retaining surface 1 at the center, so that the retaining surface 2 and the retaining surface 3 are facing each other, and are configured to retain the portable terminal casings 20. That is, the retaining jigs 10 are each configured by coupling the retaining surface 1, the retaining surface 2, and the retaining surface 3 in a U shape, and are provided in the shape of an inverted U shape so that the retaining surface 1 being the bottom of the U shape comes to be the top surface.

With the retaining surfaces 1 to 3 being provided as above, the portable terminal casing 20 can be retained on the retaining surface 1 by bringing a surface oppositely facing the first surface of the portable terminal casing 20 into contact with the retaining surface 1 so that the first surface being the print target surface of the portable terminal casing 20 is exposed. Further, the portable terminal casing 20 can be retained on the retaining surface 2 positioned on the lateral side of the retaining surface 1 by bringing the surface oppositely facing the first surface of the portable terminal casing 20 into contact with the retaining surface 2 so that the second surface adjacent to the first surface is exposed. Further, the portable terminal casing 20 can be retained on the retaining surface 3 positioned on the lateral side of the retaining surface 1 and facing the retaining surface 2 by bringing the surface oppositely facing the first surface of the portable terminal casing 20 into contact with the retaining surface 3 so that the third surface adjacent to the first surface and oppositely facing the second surface is exposed. That is, the retaining jigs 10 are each configured to retain three portable terminal casings 20 by arranging one of the first surface, the second surface, and the third surface of each of the three portable terminal casings 20 adjacent to each other, and bringing the boundaries of the adjacent surface into contact so as to form the print target surfaces from these three surfaces.

As above, if one print target surface is selected from each of the three portable terminal casings 20, they are arranged adjacently to bring their boundaries into contact and combined, and the print data identical to the print data to be printed on the print target surfaces of one portable terminal casing 20 is printed, one of the print target surfaces is printed in each portable terminal casings 20. Further, if the position to retain each portable terminal casing 20 is switched, one of remaining two surfaces to which printing has not yet been performed in each portable terminal casing 20 is selected, these are adjacently arranged so as to be combined by bringing their boundaries into contact, and printing is performed for the same print data as above, a state in which printing is performed on two of the print target surfaces in each portable terminal casing 20 is assumed. Finally, the remaining one surface on which printing has not yet been performed in each portable terminal casing 20 is selected, these are adjacently arranged so as to be combined by bringing their boundaries into contact, and the positions to retain the portable terminal casings 20 are switched so as to correspond to the print target surfaces of a single portable terminal casing 20. Further, printing is performed on all of the print target surfaces of each portable terminal casing 20 by printing the same print data as above on the print target surfaces formed by switching the position of each portable terminal casing 20.

As above, according to the retaining jig 10, the printing on the print target surfaces configured of the adjacent three surfaces can be performed efficiently for the portable terminal casings 20. Further, since printing is performed by adjacently arranging the respective print target surfaces of the plurality of portable terminal casings 20 and bringing the boundaries of the adjacent print target surfaces into contact, the print data obtained by printing on each surface among the print target surfaces in the case of printing continuous print data on the print target surfaces configured of the adjacent three surfaces are connected without any disconnection. Accordingly, portable terminal casings 20 having the continuous print data printed on the three surfaces can be obtained efficiently.

The retaining jigs 10 further include the fixing sections 11 that fixe the portable terminal casings 20 respectively to the retaining surface 2 and retaining surface 3, and the fixing sections 11 are provided so as to sandwich the portable terminal casings 20 between them and the retaining surface 2 or the retaining surface 3.

According to the above configuration, the portable terminal casings 20 can be fixed to the retaining surface 2 and the retaining surface 3 by sandwiching the portable terminal casing 20 between the retaining surface 2 and the fixing section 11, and sandwiching the portable terminal casing 20 between the retaining surface 3 and the fixing section 11. Further, as for the retaining surface 1, the portable terminal casing 20 can be retained simply by mounting the portable terminal casing 20 thereon.

The print device 100 includes the retaining jigs 10. Due to this, effects similar to the retaining jigs 10 can be obtained.

The print method is a method to print the print data on the print target surfaces that are configured of the plurality of adjacent surfaces in the polyhedrons retained in the retaining jigs 10, and including: a first retaining step that retains the plurality of polyhedrons on the retaining jigs 10 such that the one of the print target surfaces in each of the plurality of the polyhedrons is arranged adjacently to each other, the boundaries of the adjacent print target surfaces are brought into contact, and the print target surfaces for printing the print data are formed from the surfaces of the plurality of polyhedrons; a first printing step that prints the print data on the print target surfaces configured of the surfaces of the plurality of polyhedrons retained in the retaining jigs 10; a second retaining step that retains, by switching positions of the plurality of polyhedrons within the retaining jigs 10, so that a surface that is different from the printed surface in each of the plurality of polyhedrons is arranged adjacently to each other, the boundaries of the adjacent surfaces are brought into contact, and the print target surfaces for printing the print data are formed from the surfaces of the plurality of polyhedrons; and a second printing step that prints the print data on the print target surfaces configured of the surfaces of the plurality of polyhedrons retained after having switched the positions, wherein the second retaining step and the second printing step are repeated until printing is performed on all of the print target surfaces in each of the plurality of polyhedrons.

According to the above configuration, firstly, in the first retaining step, the plurality of polyhedrons is retained in the retaining jigs 10. At this occasion, the plurality of polyhedrons is retained by adjacently arranging one print target surface of each of the plurality of polyhedrons, and bringing the boundaries of the adjacent print target surfaces into contact so that the print target surfaces for printing the print data are formed from the surfaces of the plurality of polyhedrons, where the print data is identical to the print data to be printed on one polyhedron. Next, in the first printing step, the print data is printed on the print target surfaces configured of the surfaces of the plurality of polyhedrons retained in the first retaining step. Due to this, printing is performed on the first ones of the surfaces among the print target surfaces in the respective polyhedrons.

Further, in the second retaining step, the positions of the polyhedrons are switched in the retaining jig 10 and retained such that a surface different from the printed surface as above is arranged adjacently in the polyhedrons, the boundaries of the adjacent print target surfaces are brought into contact, and the print target surfaces for printing the print data identical to the first printing step is formed. Next, in the second printing step, the print data identical to the first printing step is printed on the print target surfaces configured of the surfaces of the plurality of polyhedrons retained by the positions having been switched in the second retaining step. Due to this, printing is performed on the second ones of the surfaces among the print target surfaces in the respective polyhedrons.

As above, by repeating such printing by switching the positions of the polyhedrons and retaining the same in the retaining jigs 10 so that the print target surfaces for printing the print data are formed by the surfaces different from the already-printed surfaces until the print data is printed on all of the print target surfaces of the respective polyhedrons, the printing of the print data onto the plurality of polyhedrons can be performed efficiently.

The print method is a print method to print the print data on the print target surfaces that are configured of the three surfaces, namely the first surface, and the second surface and the third surface that are adjacent to the first surface and facing each other, in the portable terminal casings 20 retained in the retaining jigs 10 provided with the three retaining surfaces 1 to 3, the method including: a first printing step that prints the print data on print target surfaces configured of the first surface of a first portable terminal casing 20 retained on the retaining surface 1, the second surface of a second portable terminal casing 20 retained on the retaining surface 2, and the third surface of a third portable terminal casing 20 retained on the retaining surface 3, and in which the boundaries of the adjacent surfaces make contact; a second printing step that prints, after the first printing step, the print data on print target surfaces configured of the first surface of the second portable terminal casing 20 retained on the retaining surface 1, the second surface of the third portable terminal casing 20 retained on the retaining surface 2, and the third surface of the first portable terminal casing 20 retained on the retaining surface 3, and in which the boundaries of the adjacent surfaces make contact; and a third printing step that prints, after the second printing step, the print data on print target surfaces configured of the first surface of the third portable terminal casing 20 retained on the retaining surface 1, the second surface of the first portable terminal casing 20 retained on the retaining surface 2, and the third surface of the second portable terminal casing 20 retained on the retaining surface 3, and in which the boundaries of the adjacent surfaces make contact.

According to the above configuration, the three portable terminal casings 20 are retained in the retaining jigs 10, and the print data is printed on the print target surfaces configured of the three surfaces, namely the first surface, and the second surface and the third surface that are adjacent to the first surface and facing each other in the portable terminal casings 20. In this print method, firstly, in the first printing step, the print data is printed on the print target surfaces configured of the first surface of the first portable terminal casing 20 retained on the retaining surface 1, the second surface of the second portable terminal casing 20 retained on the retaining surface 2, and the third surface of the third portable terminal casing 20 retained on the retaining surface 3, and in which the boundaries of the adjacent surfaces make contact. Due to this, in the three portable terminal casings 20, printing is performed on first ones of the surface among the print target surfaces configured of the three surfaces.

After the first printing step, in the second printing step, the print data is printed on the print target surfaces configured of the first surface of the second portable terminal casing 20 retained on the retaining surface 1, the second surface of the third portable terminal casing 20 retained on the retaining surface 2, and the third surface of the first portable terminal casing 20 retained on the retaining surface 3, and in which the boundaries of the adjacent surfaces make contact. Due to this, in the three portable terminal casings 20, printing is performed on second ones of the surface among the print target surfaces configured of the three surfaces.

Then, after the second printing step, in the third printing step, the print data is printed on the print target surfaces configured of the first surface of the third portable terminal casing 20 retained on the retaining surface 2, the second surface of the first portable terminal casing 20 retained on the retaining surface 2, and the third surface of the second portable terminal casing 20 retained on the retaining surface 3, and in which the boundaries of the adjacent surfaces make contact. Due to this, in the three portable terminal casings 20, printing is performed on third ones of the surface among the print target surfaces configured of the three surfaces. That is, in each of the three portable terminal casings 20, printing is performed on all of the three print target surfaces.

As above, the printing on the print target surfaces configured of the adjacent three surfaces and in which the boundaries of the adjacent surfaces make contact can be performed efficiently for the portable terminal casings 20. Further, since the printing is performed by adjacently arranging the respective print target surfaces of the plurality of portable terminal casings 20 and bringing the boundaries of the adjacent surfaces into contact, the print data obtained by printing on each surface among the print target surfaces in the case of printing continuous print data on the print target surfaces configured of the adjacent three surfaces are connected without any disconnection. Accordingly, the portable terminal casings 20 having the continuous print data printed on the three surfaces can be obtained efficiently.

The retaining jig 10 further includes the opening and closing mechanisms 50 for moving the fixing sections 11 in the direction along which the distance from the retaining surface 2 or 3 changes, with the coupling sections 12 as their axes. Due to this, the fixing sections 11 can easily be opened and closed relative to the retaining surface 2 or 3.

The present invention is not limited to the aforementioned embodiments, and various modifications and improvements can be made within the scope shown in the claims, and embodiments obtained by suitably combining technical features disclosed in the embodiments are also within the technical scope of the present invention.

### INDUSTRIAL APPLICABILITY

The present invention can be used in printing on a polyhedron having a plurality of surfaces.

### DESCRIPTION OF REFERENCE SIGNS

1 Retaining surface (first retaining surface)
2 Retaining surface (second retaining surface)
3 Retaining surface (third retaining surface)
10 Retaining jig
11 Fixing section (fixing unit)
12 Coupling section
20 Portable terminal casing (polyhedron)
30 Retaining jig tray
40 Table
50 Opening and closing mechanism (opening and closing unit)
100 Print device

1. A retaining jig that retains a plurality of polyhedrons upon printing print data on print target surfaces formed of a plurality of adjacent surfaces in the plurality of polyhedrons, wherein
the plurality of polyhedrons is retained such that one of the plurality of print target surfaces in each of the plurality of polyhedrons is arranged adjacent to each other, boundaries of the adjacent print target surfaces are brought into contact, and the print target surfaces for printing the print data are formed from surfaces of the plurality of polyhedrons.

2. The retaining jig according to claim 1, comprising:
a retaining surface for retaining each of the plurality of polyhedrons, wherein the print target surfaces for printing the print data are formed from the surfaces of the plurality of polyhedrons, such that the plurality of polyhedrons are retained by bringing the retaining surface into contact with one of the surfaces of each polyhedron, and the boundaries of the adjacent print target surfaces are brought into contact by adjacently arranging the one of the plurality of print target surfaces of the polyhedron retained by each of the retaining surfaces.

3. The retaining jig according to claim 2, further comprising:
a fixing unit that is provided to face the retaining surfaces, and sandwiches the polyhedrons between itself and the retaining surfaces and fixes the polyhedrons, wherein
the fixing unit has its one end coupled to a coupling section, and is configured to be capable of moving in a direction separating away from the retaining surfaces with the coupling section as an axis.

4. The retaining jig according to claim 2, wherein
the three retaining surfaces are provided so that a second retaining surface and a third retaining surface are facing each other and coupled to lateral side surfaces of a first retaining surface at a center, and
the three polyhedrons are retained such that a first surface in the polyhedron retained on the first retaining surface, that is oppositely facing a surface that makes contact with the first retaining surface, a second surface in the polyhedron retained on the second retaining surface, that is adjacent to a surface at a position corresponding to the first surface, and a third surface in the polyhedron retained on the third retaining surface, that is oppositely facing a surface at a position corresponding to the second surface, are adjacently arranged so that boundaries of adjacent surfaces are brought into contact, and the print target surfaces for printing the print data is formed from the surfaces of the three polyhedrons.

5. The retaining jig according to claim 4, further comprising:
fixing units that fix the polyhedrons, each of which is provided on the second retaining surface and the third retaining surface, wherein
each of the fixing units is provided to sandwich the polyhedron between itself and the second retaining surface or the third retaining surface.

6. A print device comprising the retaining jig according to claim 1.

7. A print method for printing print data on the print target surfaces that are configured of the plurality of adjacent surfaces in the plurality of polyhedrons retained in the retaining jig according to claim 1, the method comprising:
a first retaining step that retains the plurality of polyhedrons on the retaining jig such that the one of the print target surfaces in each of the plurality of polyhedrons is arranged adjacently to each other, the boundaries of the adjacent print target surfaces are brought into contact, and the print target surfaces for printing the print data are formed from the surfaces of the plurality of polyhedrons;
a first printing step that prints the print data on the print target surfaces configured of the surfaces of the plurality of polyhedrons retained in the retaining jig;
a second retaining step that retains, by switching positions of the plurality of polyhedrons within the retaining jig, so that a surface that is different from the printed surface in each of the plurality of polyhedrons is arranged adjacently to each other, the boundaries of the adjacent surfaces are brought into contact, and the print target surfaces for printing the print data are formed from the surfaces of the plurality of polyhedrons; and
a second printing step that prints the print data on the print target surfaces configured of the surfaces of the plurality of polyhedrons retained after having switched the positions, wherein
the second retaining step and the second printing step are repeated until printing is performed on all of the print target surfaces in each of the plurality of polyhedrons.

8. A print method for printing print data on the print target surfaces that are configured of the three surfaces, namely the first surface, and the second surface and the third surface that are adjacent to the first surface and facing each other, in the polyhedrons retained in the retaining jig according to claim 4, the method comprising:
a first printing step that prints the print data on print target surfaces configured of the first surface of a first polyhedron retained on the first retaining surface, the second surface of a second polyhedron retained on the second retaining surface, and the third surface of a third polyhedron retained on the third retaining surface, and in which the boundaries of the adjacent surfaces make contact;
a second printing step that prints, after the first printing step, the print data on print target surfaces configured of the first surface of the second polyhedron retained on the first retaining surface, the second surface of the third polyhedron retained on the second retaining surface, and the third surface of the first polyhedron retained on the third retaining surface, and in which the boundaries of the adjacent surfaces make contact; and
a third printing step that prints, after the second printing step, the print data on print target surfaces configured of the first surface of the third polyhedron retained on the first retaining surface, the second surface of the first polyhedron retained on the second retaining surface, and the third surface of the second polyhedron retained on the third retaining surface, and in which the boundaries of the adjacent surfaces make contact.

9. The retaining jig according to claim 3, further comprising:
an opening and closing unit that moves the fixing unit in a direction along which a distance from the retaining surfaces change with the coupling section as the axis.
